(19) United States
(12) Patent Application Publication
(10) Pub. No.: US 2025/0333608 A1
(43) Pub. Date: Oct. 30, 2025

(54) Optical Agent Encapsulation for Use in Applying Substrate Layer and Method of Making the Same

(71) Applicant: The Boeing Company, Arlington, VA (US)

(72) Inventors: Binil Itty Ipe Kandapallil, Long Beach, CA (US); Timothy Robert Kilgore, Orange, CA (US); Phillip Charles Reid, North Tustin, CA (US); Kristen Moffatt, Orange, CA (US); Juliana Sanoe Tampus, Tustin, CA (US); John Gerhard Keller, Rancho Palos Verdes, CA (US)

(21) Appl. No.: 18/649,175

(22) Filed: Apr. 29, 2024

(51) Int. Cl. C09D 5/16; B01J 13/18; B64C 1/00; C09D 5/22; C09D 7/40; C09D 7/41; C09D 7/61; C09D 7/80; C09D 175/14

(52) U.S. Cl. CPC C09D 5/1662; B01J 13/185; B64C 1/00; C09D 5/22; C09D 7/41; C09D 7/61; C09D 7/70; C09D 7/80; C09D 175/14; B64C 2001/0054

(57) ABSTRACT

An encapsulation and methods for encapsulating a UV-curable resin-filler system content containing optical agents and delivering to a substrate an encapsulated UV-curable resin-filler system containing optical agents, to form a UV-curable and UV-cured layer that can be an ultrathin layer comprising an optical agent mixture released from ruptured encapsulations.

### TECHNOLOGICAL FIELD

The present disclosure relates generally to the field of coating carrier methodology and methods for delivering coatings to substrate surfaces. More specifically the present disclosure relates to the field of encapsulating optically active components for an ultrathin coating and methods of delivering ultrathin coatings to a substrate surface.

### BACKGROUND

Thin films have found use in substrate surfaces as sensors, displays, and other useful functions. Thin films containing optical agents of interest have been applied to selected substrate surfaces via spraying, dip-coating, transfer printing, chemical vapor deposition and/or atomic layer deposition methods. Typical application methods for depositing optical agent films, layers, etc., have been expensive processes and can be limited in their use due a substrate's dimension, shape, surface features, and/or composition. A more cost-effective and more standardized application methodology for optical agent application would be highly advantageous.

Unless explicitly identified as such, no statement herein is admitted as prior art merely by its inclusion in the Technological Field and/or Background section.

### SUMMARY

Present aspects are directed to an encapsulation and methods for encapsulating a composite resin-filler system content containing optical agents and delivering to a substrate an encapsulated resin-filler system containing optical agents that can be composite resin-filler system, to form a layer that can be an ultrathin layer comprising an optical agent mixture released from ruptured encapsulations. The encapsulated contents and the encapsulation shell can be tailored and/or tuned and/or otherwise modified by controlling and modifying, for example, the encapsulation shell thickness of the encapsulation shell, and where the encapsulated resin-filler system optical agent mixture encapsulation contents and the encapsulation shell comprise the same UV-curable material.

A present aspect is directed to a method for making an optical agent mixture encapsulation, with the method including delivering a selected initial volume of a UV-curable hydrophobic resin mixture from a UV-curable hydrophobic resin delivery device into an aqueous solution (referred to equivalently herein as an “aqueous media”), and with the UV-curable hydrophobic resin delivery device in communication with a UV-curable hydrophobic resin mixture supply. The UV-curable hydrophobic resin mixture includes a UV-curable hydrophobic resin material, a metal oxide material, and at least one optical agent that can be an optical agent. The method further includes forming the selected initial volume of the UV-curable hydrophobic resin mixture in the aqueous solution into a UV-curable hydrophobic resin mixture bead, with the UV-curable hydrophobic resin mixture bead including a UV-curable hydrophobic resin mixture bead outer surface, and with the UV-curable hydrophobic resin mixture bead outer surface in contact with the aqueous solution. The method further includes directing UV light from a UV light source to the UV-curable hydrophobic resin mixture bead in the aqueous solution, with the UV light having a selected UV wavelength ranging from about 315 nm to about 400 nm, and at least partially UV-curing the UV-curable hydrophobic resin mixture bead outer surface to form an at least partially UV-cured hydrophobic resin mixture bead comprising an at least partially UV-cured hydrophobic resin mixture bead outer shell comprising an at least partially UV-cured hydrophobic resin mixture bead shell thickness, and encapsulating a selected encapsulated volume of the UV-curable hydrophobic resin mixture within the at least partially UV-cured hydrophobic resin mixture bead shell to form the optical agent mixture encapsulation, with the optical agent mixture.

In another present aspect, the method further includes maintaining the UV-curable hydrophobic resin mixture bead in suspension in the aqueous solution during formation of the at least partially UV-cured hydrophobic resin bead shell.

In another present aspect, the aqueous solution includes an aqueous solution density configured to maintain the UV-curable hydrophobic resin bead in suspension in the aqueous solution during forming of the at least partially UV-cured hydrophobic resin bead shell, with the aqueous solution comprising an aqueous solution density ranging from about 40 g/cm³ to about 200 g/cm³.

In another present aspect, the UV-curable hydrophobic resin material includes at least one of a UV-curable epoxy, a UV-curable urethane acrylate, a UV-curable polyester acrylate, a UV-curable vinyl acrylate, a UV-curable polysiloxane, a UV-curable silicone, and combinations thereof.

In a further present aspect, the UV-curable hydrophobic resin material includes a UV-curable acrylic urethane.

In another present aspect, the at least one optical agent includes at least one of a dye, a pigment, a magnetic material, an electrically conductive material, and combinations thereof.

In another present aspect, the metal oxide material comprises at least one of aluminum oxide, cobalt oxide, gallium oxide, hafnium oxide, iron oxide, nickel oxide, niobium oxide, molybdenum oxide, lanthanum oxide, rhenium oxide, scandium oxide, silicon oxide, titanium oxide, tantalum oxide, vanadium oxide, tungsten oxide, yttrium oxide, zirconium oxide, and combinations thereof.

In another present aspect, the metal oxide material comprises at least one of aluminum oxide, iron oxide, tantalum oxide, titanium oxide, vanadium oxide, zirconium oxide, and combinations thereof.

In another present aspect, the metal oxide material is provided to the UV-curable hydrophobic resin material as a powdered metal oxide material, with the powdered metal oxide material provided to the UV-curable hydrophobic resin mixture in a selected amount configured to dissolve in the UV-curable hydrophobic resin material.

In another present aspect, the optical agent mixture encapsulation comprises an encapsulation efficiency greater than about 60% when the at least partially UV-cured hydrophobic resin mixture shell comprises at least partially UV-cured hydrophobic resin mixture bead shell thickness of less than about 60 μm, and further when the metal oxide material comprises a weight ratio of the metal oxide:UV-curable hydrophobic resin material of about 1.5:10.

A further present aspect is directed to the optical agent mixture encapsulation made according to the present method.

Another present aspect is directed to a substrate comprising the optical agent mixture encapsulation made according to the present method.

Another present aspect is directed to an aircraft assembly comprising the optical agent mixture encapsulation made according to the present method.

Another present aspect is directed to an aircraft comprising the optical agent mixture encapsulation made according to the method of claim 1.

A further present aspect is directed to a method for delivering optical agent mixture encapsulation to a substrate, with the method including applying the optical agent mixture encapsulation to a substrate surface, with the optical agent mixture encapsulation including an at least partially UV-cured hydrophobic resin mixture shell, an encapsulated volume of UV-curable hydrophobic resin mixture bounded by the at least partially UV-cured hydrophobic resin mixture shell, and wherein the encapsulated volume of UV-curable hydrophobic resin mixture includes a UV-curable hydrophobic resin material, a metal oxide material, and at least one optical agent, and wherein the at least partially UV-cured hydrophobic resin mixture shell and the encapsulated volume of UV-curable hydrophobic resin mixture comprise the same material composition.

In another present aspect, the method further includes rupturing the at least partially UV-cured hydrophobic resin mixture shell to form a ruptured optical agent mixture encapsulation, and releasing to the substrate the encapsulated volume of UV-curable hydrophobic resin mixture from the ruptured optical agent mixture encapsulation to form a released volume of optical agent mixture from the ruptured optical agent mixture encapsulation.

In another present aspect, the method further includes UV-curing the released volume of UV-curable hydrophobic resin mixture released to the substrate to form a UV-cured hydrophobic resin mixture to form an optical agent mixture substrate layer.

Another present aspect is directed to a substrate comprising the at least partially UV-cured encapsulation made according to a present method.

Another present aspect is directed to the at least partially UV-cured encapsulation made according to a present method.

Another present aspect is directed to an aircraft assembly comprising the at least partially UV-cured encapsulation made according to a present method.

Another present aspect is directed to an aircraft comprising the at least partially UV-cured encapsulation made according to a present method.

Another present aspect is directed to a substrate comprising the UV-cured optical agent mixture layer made according to a present method.

Another present aspect is directed to an aircraft assembly comprising the UV-cured optical agent mixture layer made according to a present method.

Another present aspect is directed to an aircraft comprising the UV-cured optical agent mixture layer made according to a present method.

Another present aspect is directed to a substrate surface treatment material layer, including a layer of encapsulated material, with the layer of encapsulated material including an at least partially UV-cured hydrophobic resin mixture outer shell configured to surround an encapsulated volume of UV-curable hydrophobic resin mixture, with the at least partially UV-cured hydrophobic resin mixture outer shell and said encapsulated volume of UV-curable hydrophobic resin mixture both comprising the same UV-curable hydrophobic resin mixture, and with the at least partially UV-cured hydrophobic resin mixture outer shell and said encapsulated volume of UV-curable hydrophobic resin mixture both comprising a hydrophobic resin material, a metal oxide material, and at least one optical.

In another present aspect, the at least partially UV-cured hydrophobic resin mixture and the encapsulated volume of UV-curable hydrophobic resin mixture both include the same hydrophobic resin material, with the hydrophobic resin material including at least one of an UV-curable epoxy, a UV-curable urethane acrylate, a UV-curable polyester acrylate, a UV-curable vinyl acrylate, a UV-curable polysiloxane, a UV-curable silicone, and combinations thereof.

In another present aspect, the at least one optical agent includes at least one of a dye, a pigment, a magnetic material, an electrically conductive material, and combinations thereof. In another present aspect, the optical agent includes an optical agent.

In another present aspect, the metal oxide material includes at least one of aluminum oxide, cobalt oxide, gallium oxide, hafnium oxide, iron oxide, nickel oxide, niobium oxide, molybdenum oxide, lanthanum oxide, rhenium oxide, scandium oxide, silicon oxide, titanium oxide, tantalum oxide, vanadium oxide, tungsten oxide, yttrium oxide, zirconium oxide, and combinations thereof.

In a further present aspect, the metal oxide material comprises at least one of aluminum oxide, iron oxide, tantalum oxide, titanium oxide, vanadium oxide, zirconium oxide, and combinations thereof.

In another present aspect, the at least partially UV-cured hydrophobic resin mixture shell and the encapsulated volume of UV-curable hydrophobic resin mixture comprises the same hydrophobic resin material mixture.

In another present aspect, the substrate surface treatment material layer is an interlayer.

In another present aspect, the substrate surface treatment material layer is an adhesive layer.

Another present aspect is directed to a substrate comprising the present substrate surface treatment material layer.

Another present aspect is directed to an aircraft assembly comprising the present substrate surface treatment material layer.

Another present aspect is directed to an aircraft comprising the present substrate surface treatment material layer.

Further present aspects are directed to a substrate surface treatment material encapsulation bead including an at least partially cured hydrophobic resin mixture encapsulation shell configured to surround and otherwise contain a selected volume of encapsulated UV-curable hydrophobic resin mixture to form the substrate surface treatment material encapsulation bead. The selected volume of encapsulated UV-curable hydrophobic resin mixture and the at least partially UV-cured hydrophobic resin mixture encapsulation shell both include the same hydrophobic resin mixture, and wherein the hydrophobic resin mixture includes a hydrophobic resin, a metal oxide material, and at least one optical agent.

In another present aspect, the optical agent includes at least one of a magnetic material, an electrically conductive material, an electrically insulative material, and combinations thereof.

In another present aspect, the optical agent is an optical agent comprising at least one of a pigment, a dye, a tracer, and combinations thereof.

In another present aspect, the at least partially UV-cured hydrophobic resin mixture encapsulation shell and the selected volume of encapsulated UV-curable hydrophobic resin mixture comprises at least one of a UV-curable epoxy, a UV-curable urethane acrylate, a UV-curable polyester acrylate, a UV-curable vinyl acrylate, a UV-curable polysiloxane, a UV-curable silicone, and combinations thereof.

In another present aspect, the metal oxide material comprises at least one of aluminum oxide, cobalt oxide, gallium oxide, hafnium oxide, iron oxide, nickel oxide, niobium oxide, molybdenum oxide, lanthanum oxide, rhenium oxide, scandium oxide, silicon oxide, titanium oxide, tantalum oxide, vanadium oxide, tungsten oxide, yttrium oxide, zirconium oxide, and combinations thereof.

In a further present aspect, the metal oxide material comprises at least one of aluminum oxide, iron oxide, tantalum oxide, titanium oxide, vanadium oxide, zirconium oxide, and combinations thereof.

In another present aspect, the at least partially UV-cured hydrophobic resin mixture encapsulation shell comprises a shell thickness ranging from about 1000 μm to about 6000 μm.

In another present aspect, the substrate surface treatment material encapsulation bead comprises an encapsulation efficiency greater than about 60% when the at least partially UV-cured hydrophobic resin mixture encapsulation shell comprises a shell thickness of less than about 60 μm, and further when the metal oxide comprises a weight ratio of the metal oxide:UV-curable hydrophobic resin material of about 1.5:10.

The features, functions and advantages that have been discussed can be achieved independently in various aspects or may be combined in yet other aspects, further details of which can be seen with reference to the following description and the drawings.

### BRIEF DESCRIPTION OF THE DRAWINGS

Having thus described variations of the disclosure in general terms, reference will now be made to the accompanying drawings, which are not necessarily drawn to scale, and wherein:

FIG. 1 is an illustration of a vehicle in the form of an aircraft, and having substrate surfaces comprising present substrate surface treatments, and according to present aspects;

FIG. 2 is an illustration of a preparation system for the present UV-curable hydrophobic resin mixture encapsulations, according to present aspects;

FIG. 3 is an illustration of a preparation system for the present UV-curable hydrophobic resin mixture encapsulations, according to present aspects;

FIGS. 4A, 4B, 4C, and 4D are FIGs. showing a progression of present at least partially UV-cured hydrophobic resin mixture encapsulations progressing through a series of steps to form a ruptured hydrophobic resin mixture encapsulation releasing a selected volume of UV-curable hydrophobic resin mixture, according to present aspects;

FIG. 5 is an overhead plan view of a container comprising a present UV-curable hydrophobic resin mixture, according to present aspects;

FIG. 6 is an overhead plan view of a container comprising present at least partially UV-cured hydrophobic resin mixture encapsulation beads in an aqueous media in ambient light, according to present aspects;

FIG. 7 is a photograph showing an enlarged view of present at least partially UV-cured hydrophobic resin mixture encapsulation beads on a substrate, according to present aspects;

FIG. 8A is photograph showing an overhead plan view of a substrate comprising a selected volume of UV-enlarged view of UV-curable hydrophobic resin mixture that can comprise an optical agent that has been released from the at least partially UV-cured hydrophobic resin mixture encapsulation beads after encapsulation rupture, according to present aspects;

FIG. 8B is a photograph showing an overhead plan view of a substrate comprising a selected volume of UV-enlarged view of UV-curable hydrophobic resin mixture that can comprise an optical agent that has been released from the at least partially UV-cured hydrophobic resin mixture encapsulation beads after encapsulation rupture and that is subjected to UV-curing, according to present aspects;

FIG. 8C is photograph showing an overhead plan view of a substrate comprising a selected volume of UV-enlarged view of UV-curable hydrophobic resin mixture that can comprise an optical agent that has been released from the at least partially UV-cured hydrophobic resin mixture encapsulation beads after encapsulation rupture and that has been UV-cured to form a surface treatment layer, according to present aspects;

FIG. 9 is a graph illustrating surface treatment layer radiance of surface treatment layers formed from the release of a selected amount of UV-curable hydrophobic resin mixture containing zirconium oxide filler after release from encapsulation and after further UV-curing, according to present aspects;

FIG. 10 is a chart showing encapsulation efficiency plotted relative to encapsulation shell thickness in micrometers, according to present aspects;

FIG. 11A is a representative illustration, not drawn to scale, of a substrate surface comprising a plurality of at least partially UV-cured hydrophobic resin mixture encapsulation beads on the substrate surface in as pre-ruptured state, according to present aspects;

FIG. 11B is a representative illustration, not drawn to scale, of a plurality of at least partially UV-cured hydrophobic resin mixture encapsulation beads positioned between a first and second substrate in a pre-ruptured state, according to present aspects;

FIG. 12A is a representative illustration, not drawn to scale, of a substrate surface comprising a selected volume of a UV-curable hydrophobic resin mixture released from the plurality of at least partially UV-cured hydrophobic resin mixture encapsulation beads (after rupture) on the substrate surface to form a layer of UV-curable hydrophobic resin mixture on the substrate surface, according to present aspects;

FIG. 12B is a representative illustration, not drawn to scale, of a selected volume of a UV-curable hydrophobic resin mixture released from the plurality of at least partially UV-cured hydrophobic resin mixture encapsulation beads after rupture of the beads to form an interlayer of UV-curable hydrophobic resin mixture between the first and second substrates, according to present aspects;

FIG. 13 is a box diagram outlining an aircraft comprising an aircraft assembly comprising a substrate comprising a plurality of at least partially UV-cured hydrophobic resin mixture encapsulation beads, according to present aspects;

FIG. 14 is a box diagram outlining an aircraft comprising an aircraft assembly comprising a substrate comprising a layer of UV-curable hydrophobic resin mixture released to the substrate from at least partially UV-cured hydrophobic resin mixture encapsulation beads in a ruptured state, according to present aspects.

FIG. 15 is a method flowchart outlining a method according to present aspects;

FIG. 16 is a method flowchart outlining a method according to present aspects;

FIG. 17 is a method flowchart outlining a method according to present aspects;

FIG. 18 is a method flowchart outlining a method according to present aspects; and

FIG. 19 is a method flowchart outlining a method according to present aspects.

### DETAILED DESCRIPTION

Present aspects are directed to a UV-curable encapsulated hydrophobic resin mixture that can be at least partially UV-cured to form a hydrophobic resin mixture encapsulation comprising an at least partially UV-cured to form a hydrophobic resin mixture encapsulation shell. The present encapsulations can comprise an optically detectable agent (referred to equivalently herein as an “optical agent”) in a mixture, that can be an optical agent mixture comprising an optical agent mixed with a metal oxide filler and further mixed with a UV-curable polymer that can be an acrylic urethane polymer. The optical agent can be a dye, pigment, paint that can fluoresce and/or that can possess optically active characteristics that can be detected visually, or that can be detected with instrumentation. According to further present aspects, the encapsulations can be micro-encapsulations that can be presented to, delivered to, and/or otherwise applied to a substrate and ruptured at a selected time, on demand, to controllably release a selected volume of the optical agent mixture onto a substrate in an uncured state to form an uncured optical agent layer that can be UV-cured to form a UV-cured optical agent layer on, for example, a substrate.

The optical agent can be an optical agent in a layer formed by the released optical agent on a substrate surface, with the layer in the form of a coating layer, a paint layer, that can be an adhesive layer. The layer formed can be an ultrathin layer having a thickness on the order of microns, etc., or less. In addition, the optical agent can be an optical biological tracer, an industrial tracer, etc. In addition, the present layer disposed onto a substrate from the present ruptured encapsulations can provide a layer for sensing (e.g., a sensor), as well as providing a layer comprising a selected electrical conductivity and/or a selected electrical resistance, etc.

The encapsulated contents and the encapsulation shell can be tailored and/or tuned and/or otherwise modified by controlling and modifying, for example, the encapsulation formulation to achieve a selected shell thickness of the encapsulation shell, and a selected high encapsulation efficiency ranging between about 50% and 65%, and where the encapsulated resin-filler system content and the encapsulation shell both comprise the same UV-curable optical agent/metal oxide/acrylic urethane mixture, with the shell being in an at least partially-cured state, and the encapsulated contents being in a UV-curable (e.g., uncured) state.

Present aspects are directed to methods of making the present encapsulations, methods of applying the present encapsulations to a substrate, methods of making optically active layers on substrates by rupturing the applied encapsulations and otherwise delivering the contents of the encapsulations to a substrate at a selected high encapsulation efficiency, and objects, structures, assemblies that comprise the encapsulations either in an intact state (e.g., a non-ruptured state), and/or in a ruptured state that releases the UV-curable contents of the encapsulations to form a layer of UV-curable optically active material on a substrate of an assembly of, for example, an aircraft.

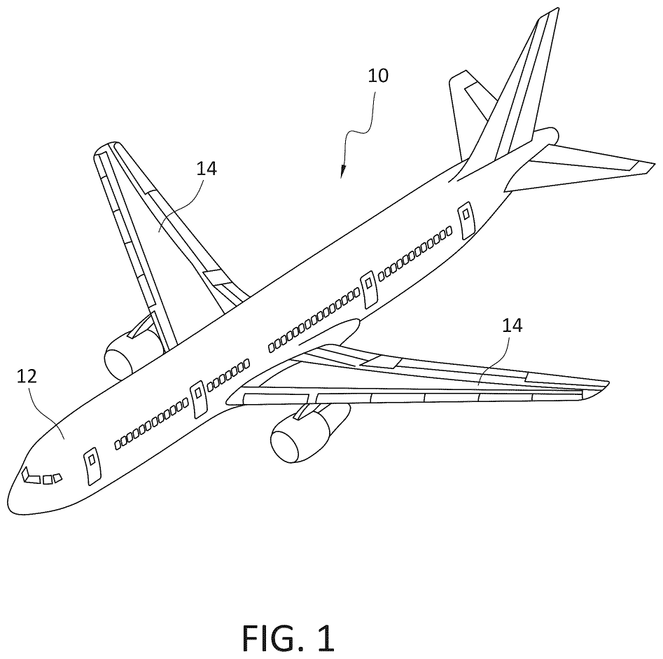

According to present aspects, FIG. 1 is an illustration of a vehicle in the form of an aircraft 10 that can comprise aircraft assemblies including aircraft assemblies forming a fuselage 12, and wings 14 that can incorporate the presently disclosed encapsulations, with the aircraft assemblies, further comprising at least one substrate layer on a substrate that comprises UV-cured and/or UV-cured optical agent mixture material released from the present encapsulations.

Further present aspects are directed to UV-cured encapsulations as configured carriers and/or delivery devices of a UV-curable optical agent mixture (e.g., optical agent mixtures that can include dyes, pigments, paints, industrial tracers), with the encapsulations that have a shell comprising mechanical barrier characteristics (e.g., robustness, mechanical strength, etc.) that can act as a barrier and carrier to protect the encapsulated UV-curable contents, and to further facilitate the storage of and transportation of the manufactured encapsulations themselves to a point of use (referred to equivalently herein as a “site of interest”) that can be located remotely from the point of encapsulation manufacture. The term “industrial tracers” refers to compound and materials that can themselves be present as layers, and/or that can be incorporated into layers (including “smart” layers), and that can be configured to detect physical or chemical properties of a substrate and that can “sense” or otherwise detect properties including but not limited to wear, corrosion, leakage, delamination, need for rework, maintenance scheduling, etc.

The incorporation of optically active layers onto substrates, including substrates that can comprise one or more optical agents, can typically require supplying coating mixtures, including coating mixtures (e.g., for the formation of an ultrathin coating layer having, for example, coating thicknesses in the micron) in a coating mixture supply located on-site where the coating process is to occur. The preparation of and availability of typical coating mixtures, including UV-curable coating mixtures, can result in significant waste, as coating mixture pot life necessitates that coating processes be conducted within an operational “window” of time before the coating material sets, begins to cure, or otherwise becomes unsuitable for use as a coating that can be applied to a substrate.

According to present aspects, improved encapsulation methods are presented for a substrate treatment material mixture that can be applied to a substrate surface of a substrate to form coatings that can incorporate optical agents such as paints, pigments, dyes, tracers, tags, etc. The present encapsulation methods can be a “single-step” encapsulation method where a substrate treatment material is UV-curable and is at least partially UV-cured to form a UV-cured encapsulation shell having a selected encapsulation shell (e.g., encapsulation wall) thickness, and wherein the encapsulation in the at least partially UV-cured state comprises a selected high encapsulation efficiency value that is configured to maximize the useful coating volume of an encapsulated optical agent mixture that is released at the site of interest (e.g., the selected substrate, etc.) from the at least partially UV-cured encapsulation.

The use of the present optical agent mixture encapsulations delivered to specific substrates and further delivered to specific regions of specific substrates results in a significantly improved controlled delivery methodology of selected amounts of optical agent to a site of interest. In addition, the application of the present encapsulations can be configured to be a “dry” delivery technique for a material (e.g., coating material, adhesive resin material, coating material layer, adhesive resin material layer, etc.) as compared with the typical “wet” application methods of a coating material that is supplied to a substrate from a “wet” delivery supply or source (e.g., a paint shed or coating material station comprising brushing, spraying techniques, or significantly more expensive material deposition techniques that can include vapor deposition processes, etc.) that is, for example, maintained at a centralized coating application station within a manufacturing facility. In other words, the present encapsulations can act as a barrier for, and otherwise protect “wet” encapsulated contents, with the encapsulations configured to contain the contents during application, and then, on demand, be configured to rupture to release the contents to a site of interest.

According to present aspects, the encapsulations can be manufactured at one site, and then stored to avoid the “pot-life” issues typically confronted with UV-curable coatings, adhesives, and other applied materials where such “exposed” and “wet” materials and substrate surface preparations must be used and/or applied to a substrate within a restrictive timing window (e.g., material application regimen) before the material begins to cure in the “pot”, loses agent properties, or otherwise becomes no longer useful, leading to significant material waste, higher labor cost, higher material cost, increased processing time, etc.

In addition, the present encapsulations provide a “closed system” that can significantly reduce and/or eliminate the possibility of unwanted foreign material contacting a particular coating material that could deleteriously impact the performance of a selected optical agent, as compared to typical “wet” processes where a supply of a coating material mixture may be exposed to an environment in a manufacturing facility prior to and during use, for example.

According to present aspects, and as explained and presented herein, the encapsulation shell will not interfere with physical and/or chemical characteristics of the encapsulated contents, as there is a complete identity of material. That is, according to present aspects, the UV-curable hydrophobic resin mixture material that is formed into “beads” comprises an at least partially UV-cured hydrophobic resin mixture material shell that is formed to encapsulate a selected volume of the same uncured and UV-curable hydrophobic resin mixture material such that the at least partially UV-cured encapsulation shell and the uncured encapsulated contents within the shell are identical in material composition, with the only difference being the cure “state” of the (at least partially UV-cured) shell and the encapsulated UV-curable contents that are in an “uncured state,” uncured during their encapsulation.

According to one present example, the present UV-curable hydrophobic resin mixture can comprise a UV-curable acrylic urethane resin material in combination with a metal oxide filler material that is in further combination with at least one optical agent. The selection of the UV-curable acrylic urethane resin material and the metal oxide filler material are selected to not interfere with the intended performance characteristics of the optical agent in an applied state, that can be a UV-cured state, at a site of interest.

The metal oxide component can comprise at least one of aluminum oxide, cobalt oxide, gallium oxide, hafnium oxide, iron oxide, nickel oxide, niobium oxide, molybdenum oxide, lanthanum oxide, rhenium oxide, scandium oxide, silicon oxide, titanium oxide, tantalum oxide, vanadium oxide, tungsten oxide, yttrium oxide, zirconium oxide, and combinations thereof. In another example, the metal oxide component can comprise at least one of aluminum oxide, iron oxide, tantalum oxide, titanium oxide, vanadium oxide, zirconium oxide, and combinations thereof.

While being bound to no particular theory, according to present aspects, the metal oxide component in the UV-curable hydrophobic resin material mixture is believed to reflect and scatter UV-light to which the metal oxide is exposed. In one present example, a present UV-curable hydrophobic resin material mixture incorporates selected amounts of zirconium oxide (referred to equivalently herein as “zirconia”, “zirconium dioxide”, and represented collectively as “ZrO₂”) with the UV-curable acrylic urethane and the optical agent. Zirconium oxide in the present UV-curable hydrophobic resin material mixtures has been discovered to display significant UV-light reflectivity and UV-light scattering that enables a significantly faster and desirable degree of UV-curing of the present UV-curable hydrophobic resin material mixture outer regions to form thin UV-cured shells that significantly impact and otherwise provide a selected high encapsulation efficiency.

In addition, according to present aspects, and as described herein, the encapsulation shells formed during the at least partial UV-curing of the present UV-curable hydrophobic resin material mixtures materials can be formed to a selected shell thickness within a selected UV-curing time by altering the concentration of the zirconium oxide incorporated into the present UV-curable hydrophobic resin material mixtures. That is, according to present aspects, the encapsulation shell thickness can be selectively “tuned” and/or selectively “tailored” (and otherwise selectively altered to achieve a selected shell thickness) by varying the concentration of the zirconium oxide incorporated into the present UV-curable hydrophobic resin material mixtures.

As further explained herein, significant advantages are realized through the use of the present at least partially UV-cured hydrophobic resin material encapsulations (referred to equivalently as “beads” and or “capsules”) as delivery devices for the present encapsulated optical agent mixtures to a site of interest (e.g., a substrate, substrate surface, that can be a substrate and/or substrate surface of a larger assembly that can include, for example, an aircraft).

As explained herein, the balance between a selected encapsulation shell thickness (referred to equivalently herein as an “encapsulation wall thickness”) and the amount of encapsulated contents that can be delivered to a substrate when the encapsulation is ruptured can be described in terms of encapsulation efficiency. As described herein, the encapsulation efficiency of an encapsulation can be determined by comparing the weight of the encapsulation to the weight of the encapsulated content that is released from the encapsulation upon rupture of the encapsulation. While present shells of various thicknesses can protect the present contents that can be controllably delivered to a site of interest, present aspects contemplate and achieve an encapsulation efficiency greater than about 50% and preferably greater than about 60% according to the encapsulation and encapsulation methods of the present disclosure.

According to present aspects, the encapsulations are at least partially UV-cured by exposure to UV-light at, for example, 405 nm that can produce an encapsulation having an average encapsulation diameter of from about 0.1 centimeters (cm) to about 0.5 centimeters (cm). In another example, the encapsulation can have an average encapsulation diameter ranging from about 2 millimeters (mm) to about 5 millimeter (mm), with, according to one example, an at least partially UV-cured encapsulation shell thickness ranging from about 100 micrometers (μm) to about 200 micrometers (μm).

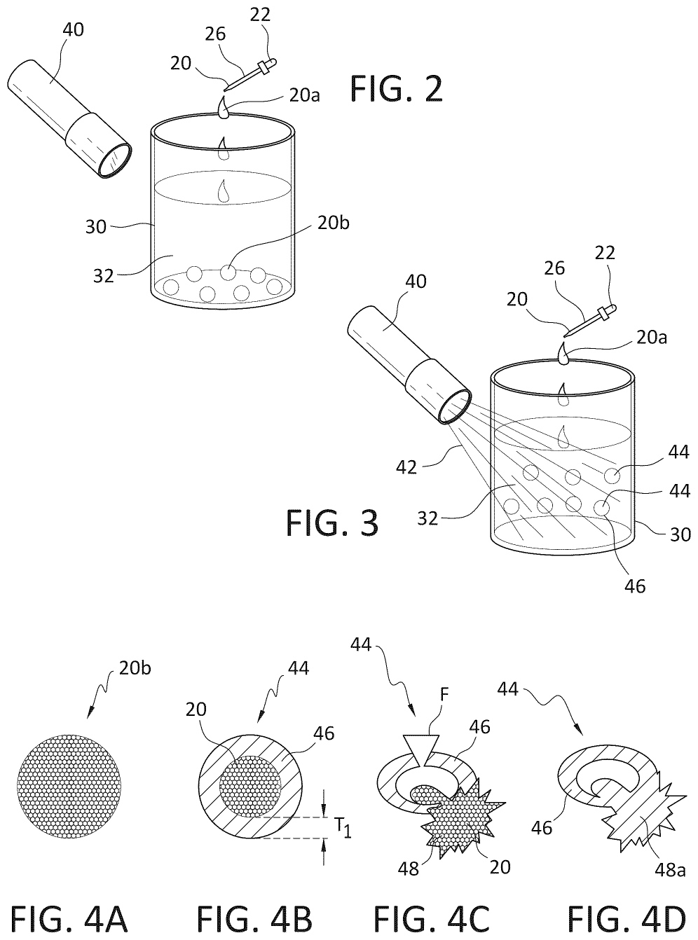

As stated herein, according to present aspects, an optically active coating material that incorporates a UV-curable optical agent mixture is encapsulated within a UV-cured encapsulation shell that is made from the same material as the encapsulated contents. FIG. 2 illustrates a manufacturing method for preparing the present encapsulations. As shown in FIG. 2, according to a present method, a UV-curable hydrophobic resin mixture drop 20a from a UV-curable hydrophobic resin mixture supply 22 (comprising a UV-curable acrylic urethane mixed with a metal oxide filler and an optical agent) can be fabricated into a UV-curable hydrophobic resin mixture sphere 20b by delivering a selected amount of the UV-curable hydrophobic resin mixture 20 to an aqueous medium 32 contained in a vessel 30 from a delivery device 26 that can be, for example, a pipette.

As shown in FIG. 2, a delivery device 26 is configured to dispense the UV-curable hydrophobic resin mixture 20 as “drops” or “droplets” 20a comprising a selected volume of the UV-curable hydrophobic resin mixture (from a UV-curable hydrophobic resin mixture source or supply 22 that can be a hermetically contained supply, and that further can be a preloaded supply in the delivery device 26), with the delivery device 26 configured to deliver drops of consistent and substantially equivalent selected volume from the delivery device 26 into an aqueous media 32 (referred to equivalently herein as an (aqueous solution”). In one example, the UV-curable hydrophobic resin mixture supply 22 can be delivered as a continuously delivered UV-curable hydrophobic resin mixture supply to the delivery device via a UV-curable hydrophobic resin mixture supply line (not shown in FIG. 2 or 3).

In one example, a pipette having a selected pipette opening diameter is used to dispense a substantially equivalent volume “per drop” of the present UV-curable hydrophobic resin mixture dropwise into the aqueous mixture. As the drops 20a engage the aqueous media 32, the drops configure themselves into individual UV-curable hydrophobic resin mixture “beads” 26 having a spherical or near spherical dimension, referred to equivalently herein as UV-curable hydrophobic resin mixture “spheres” 20b. The selected hydrophobicity of the present UV-curable hydrophobic resin mixture, and mixture drops in the aqueous solution configures the drops into a “shape-wise equilibrium” having a minimum surface area that approaches or achieves a spherical, or near spherical, or substantially spherical shape while suspended in the aqueous solution.

FIG. 3 shows an illustrative experimental set-up of the type as presented in FIG. 2, but with UV-light emitting device 40 now delivering UV-beams 42 to the aqueous media containing the UV-curable hydrophobic resin mixture sphere 20b. According to a present method, as the drops are delivered to the aqueous media, the drops are exposed in the aqueous media to UV-light than can be delivered at 405 nm, with the UV-curable drops then beginning to UV-cure as evidenced by the formation of the UV-cured encapsulation shell.

In the present one-step or single-step encapsulation formation method, the UV-curable hydrophobic resin mixture that is exposed to UV-curing forms the present UV-cured encapsulations. The UV-light 42 from a UV-light emitting device 40 begins to cure the outer surface of the UV-curable hydrophobic resin mixture sphere 20b into an at least partially cured UV-curable hydrophobic resin mixture encapsulation 44 comprising an at least partially UV-cured hydrophobic resin mixture shell 46.

FIGS. 4A, 4B, 4C and 4D show a progression from the UV-curable hydrophobic resin mixture sphere 20b to an at least partially cured UV-curable hydrophobic resin mixture encapsulation 44 comprising an at least partially UV-cured hydrophobic resin mixture shell 46, that can then be ruptured to release the contained and encapsulated UV-curable hydrophobic resin mixture from the at least partially UV-cured hydrophobic resin mixture encapsulation 44 comprising an at least partially UV-cured hydrophobic resin mixture shell 46.

FIG. 4A is an enlarged cross-sectional view of a UV-curable hydrophobic resin mixture sphere 20b of the type shown in FIG. 2, with no UV-curing yet occurring and no encapsulation shell yet formed. FIG. 4B shows an enlarged cross-sectional view of an at least partially UV-cured hydrophobic resin mixture encapsulation 44 comprising an at least partially UV-cured hydrophobic resin mixture shell 46 encapsulating a selected amount of (e.g., uncured) UV-curable hydrophobic resin mixture, in an uncured state, contained within the encapsulation 44.

FIG. 4C is an enlarged cross-sectional view of an at least partially UV-cured hydrophobic resin mixture encapsulation 44 having a force (F) applied to the at least partially UV-cured hydrophobic resin mixture encapsulation 44, with the force (F) applied presently contemplated to be, for example, an elevated environmental pressure (inward compressive pressure), or a reduced pressure (vacuum applied resulting in an outward pressure), a physical element (e.g., a plate or a device configured to pierce the shell 46), and forces applied including ultrasonic energy, infrared (IR) energy; radio frequency (RF) energy, laser, etc. that can be configured to rupture the at least partially UV-cured hydrophobic resin mixture encapsulations 44, including targeted regions of substrates comprising the at least partially UV-cured hydrophobic resin mixture encapsulations.

FIG. 4C shows the at least partially UV-cured hydrophobic resin mixture encapsulation 44 with force/pressure applied and with the at least partially UV-cured hydrophobic resin mixture shell 46 in the ruptured state now configured to release (uncured) UV-curable hydrophobic resin mixture 48 from the ruptured encapsulation, and with the uncured UV-curable hydrophobic resin mixture now released from the encapsulation and onto, for example, a substrate (not shown in FIG. 4C).

FIG. 4D shows a further step in a representative progression, according to present aspects, where the (uncured) UV-curable hydrophobic resin mixture 48 (released from the ruptured encapsulation 44) is subjected to subsequent UV-curing, with the (uncured) UV-curable hydrophobic resin mixture 48 now cured and converted into a UV-cured hydrophobic resin material layer 48a. As shown in FIG. 4D, the UV-curable hydrophobic resin mixture 48 is released from the encapsulation 44, and the released at least partially UV-cured hydrophobic resin mixture 48 is UV-cured and converted into a UV-cured hydrophobic resin material layer 48a. As shown in FIG. 4D, the ruptured at least partially UV-cured hydrophobic resin mixture encapsulation shell 46 of encapsulation 44 becomes a part of the UV-cured hydrophobic resin material layer 48a.

Since the material composition of the ruptured UV-cured hydrophobic resin material shell 46 is identical to the released UV-curable hydrophobic resin mixture 48, the UV-cured hydrophobic resin material layer 48a comprises compositionally compatible components that do not interfere with the physical and/or chemical properties and performance of the optically active agents that disposed on a substrate in the UV-cured hydrophobic resin material layer 48a.

A non-limiting representative synthesis for the present UV-curable hydrophobic resin mixture is presented in the experimental Example 1.

### Example 1

UV-reactive/photocurable hydrophobic resin mixture synthesis

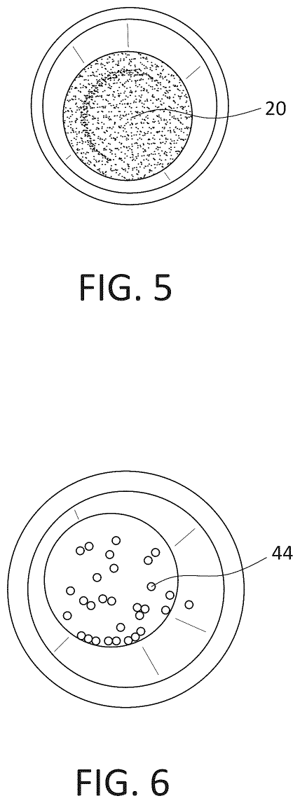

A metal oxide (zinc oxide) powder (0.5 g) was combined into a commercially available photocurable (UV-curable) acrylic urethane resin (5 g). An organic fluorescent dye was incorporated into the metal oxide/acrylic urethane resin mixture. The mixture was thoroughly mixed using a FlackTex mixer for 3 minutes at 3000 rpm. The organic solvent in the organic soluble fluorescent dye was removed by purging the mixture with nitrogen. The resulting hydrophobic (acrylic urethane) resin mixture formed a slurry (e.g., a suspension) and was used in the preparation of the UV-curable hydrophobic (acrylic urethane) resin mixture encapsulations. FIG. 5 shows an amount of resulting hydrophobic (acrylic urethane) resin mixture formed into a slurry that can become the UV-curable hydrophobic resin mixture 20.

The use of the present UV-curable hydrophobic resin mixture to form the present at least partially-cured encapsulations is presented in the experimental Example 2.

### Example 2

### Encapsulation Synthesis-UV-Curable (Acrylic Urethane) Hydrophobic Resin Mixture

The UV-curable hydrophobic (acrylic urethane) resin mixture in slurry form (e.g., a suspension) was slowly added dropwise from a pipette having an inner diameter of 0.3 millimeter (mm) to 0.6 millimeter (mm) diameter opening into an aqueous saline solution comprising deionized water solution and sodium chloride. Without being bound to any particular theory, the hydrophobicity of the drops in the aqueous saline solution facilitated the drops acquiring and maintaining a nearly spherical shape as the drops obtained a geometric orientation having and seeking the lowest surface area (being a sphere a near spherical orientation, and/or a substantially spherical orientation; referred to equivalently herein as “beads”). As the drops formed into beads in the solution, UV light (emitting at 405 nm) from a UV light source was directed to the solution and the forming spherical encapsulations, or capsules, in the solution.

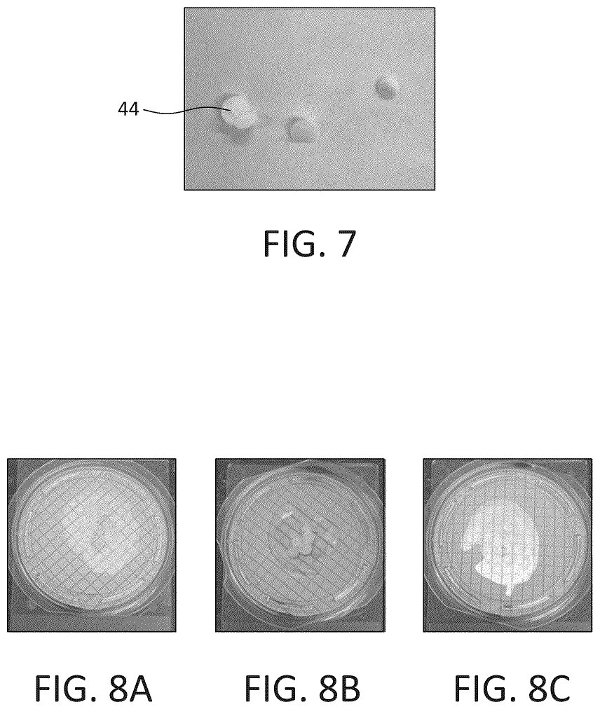

In the aqueous solution (that can be a saline solution), the drops descended to the bottom of the testing vessel and were collected after UV exposure ranging from about 5 minutes to about 10 mins. An increase in solution salinity is believed to retain the UV-curing spheres in a suspended state in the testing vessel to, for example, facilitation the harvesting (i.e., removal) of the UV-cured sphere from the testing solution. That is, present aspects contemplate regulating the salinity of the solution (and the associated density g/cm³ of the solution) to achieve a selected specific displacement of the UV-cured sphere encapsulations from the bottom of the vessel in which the beads 44 were formed. See FIG. 6. FIG. 7 is an enlarged overhead view of the at least partially UV-cured hydrophobic resin mixture encapsulations in the form of spheres that can be made according to presently disclosed methods.

According to present aspects, maintaining the UV-curable and UV-curing beads in suspension in the aqueous media can increase the uniformity of the UV curing and can ensure that the beads subjected to UV-curing reach and otherwise achieve a selected state of UV-cure prior to the beads, for example, descending to the bottom of the vessel. According to present aspects, the specific gravity of the beads in the aqueous media can be adjusted by increasing the salinity of the aqueous media salts that can convert an aqueous media into a saline solution having a selected salinity ranging from about 40 g/cm³ to about 200 g/cm³. According to present aspects, adjusting the salinity (e.g., the density) of the aqueous media can provide sufficient UV exposure time prior to the beads contacting the bottom of the vessel, and can further be adjusted such that the beads can continually remain in a suspended state within the aqueous media during encapsulation shell formation, for example.

According to present aspects, the UV-cure regimen selected (e.g., the degree of UV exposure in terms of, for example, wavelength intensity and UV-light exposure time combined) can result in the formation of a selected thickness of the at least partially UV-cured outer shell of the encapsulations, and can further result in the selected and tunable mechanical properties of the encapsulation outer shell including, for example, various measurable characteristics relating to mechanical strength of the encapsulations. Mechanical strength of the encapsulation shell can facilitate the rupture of the fabricated at least partially cured encapsulation shell at a selected rupture force. According to one present example, the mechanical strength of the encapsulation shell can be selected to allow shell rupture at an applied pressure ranging from about 275 psi to about 400 psi. In another present example, the mechanical strength of the encapsulation shell can be selected to allow shell rupture at an applied pressure ranging from about 240 psi to about 400 psi.

### Example 3

### Rupture of Encapsulations/Release of Hydrophobic Optical Agent in Resin Mixture

After harvesting the encapsulations from the solution by direct manual or automated removal (e.g., via filtration, etc.), the at least partially UV-cured hydrophobic resin mixture encapsulations comprising the acrylic urethane optical agent mixture were ruptured on a substrate for optical characterization of the released encapsulated contents. See FIGS. 8A, 8B, 8C. Encapsulated samples comprising varied dye systems (e.g. paints) were evaluated, with different acrylic urethane formulations used alone and in combination. Two dye systems emitting light at 540 nm and 620 nm were used in the tested formulations that further comprised amounts of zirconium oxide present as the metal oxide filler material in the UV-curable hydrophobic resin material mixtures tested. Images of the ruptured capsules under 405 nm UV illumination containing Formulations A, B, and A+B, respectively, are shown in FIGS. 8A, 8B, and 8C. The radiant intensity of the dye systems was shown to be tailorable or “tunable” by varying the concentration of the dyes in the optical agent mixture (referred to herein as the UV-curable hydrophobic resin mixture) that formed the encapsulations.

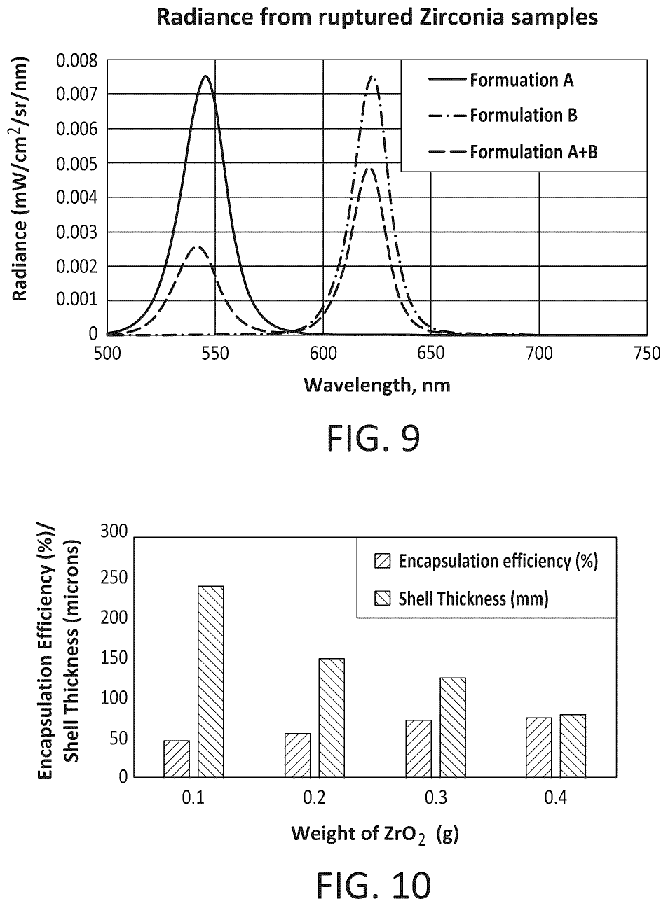

FIG. 9 is a graph plotting the observed radiance of the various optical agent mixtures (Formulations A, B, A+B) released from the ruptured encapsulations comprising the three differing acrylic urethane and dye formulations. The released dyes were excited using a 405 nm monochromatic light source (5 W/m²sr).

According to present aspects, encapsulation efficiency is defined herein as the average weight of releasable content from an at least partially cured encapsulation (e.g., “capsule”). The encapsulation efficiency of the present optical agent mixtures comprising the optical agent, the metal oxide filler and the acrylic urethane was calculated by measuring weight differences of the individual encapsulations before and after rupture (e.g., measurements taken with and without the cured shell present). A summary of the encapsulation efficiencies obtained for different encapsulation formulations is presented in Table 1.

TABLE 1

| | Full | Empty | | | |
|---|---|---|---|---|---|
| Optical Agent | Encapsulation | Encapsulation | Delta | | Average |
| Mixture | (g) | (g) | (g) | % | Wt % |
| Formulation | 0.032 | 0.014 | 0.018 | 57.3 | 61.2 |
| A | 0.034 | 0.013 | 0.021 | 63.0 | |
| | 0.035 | 0.013 | 0.022 | 63.4 | |
| Formulation | 0.037 | 0.027 | 0.010 | 27.0 | 28.4 |
| B | 0.036 | 0.026 | 0.010 | 28.0 | |
| | 0.039 | 0.027 | 0.010 | 30.3 | |
| Formulation | 0.063 | 0.036 | 0.026 | 42.1 | 46.6 |
| A + B | 0.072 | 0.037 | 0.035 | 49.1 | |
| | 0.023 | 0.012 | 0.011 | 48.5 | |

The encapsulation shell thickness and encapsulation efficiency of the present encapsulation systems can be impacted by varying the concentration of the metal oxide filler material in the optical agent mixture formulation. As shown in FIG. 10, the encapsulation efficiency (%) is plotted for a particular encapsulation shell thickness of a shell for an optical agent mixture formulation having the specified metal oxide amount (weight in grams). As the weight/amount of metal oxide filler selected (shown in FIG. 10 as zirconium oxide) increases from 0.1 g to 0.4 g, an increase in the amount of reflected/scattered UV-light was induced, promoting an increase in rate of photo-polymerization in the UV-curable material and resulted in the formation of an encapsulation shell having a rapid shell formation to achieve a thinner shell thickness, and resulting in an increased encapsulation efficiency (as less material contained in the encapsulation was “used” or at least partially cured to form the at least partially UV-cured encapsulation shell).

Highly reflective zirconium oxide was determined to provide a highly useful filler in the present formulations, although the present aspects are not restricted to the use of zirconium oxide as the metal oxide component for present formulations. As the zirconium oxide concentration in the present formations was increased, the present formulations comprising zirconium oxide resulted in thinner encapsulation shell formation with total amount of UV-exposure and UV-exposure time kept constant. According to present aspects, high encapsulation efficiencies of greater than about 60% were achieved by obtaining thin encapsulation shells having a selected mechanical strength using zirconium oxide as the filler material.

The encapsulations of the present disclosure, made according to presently disclosed methods, can be manufactured, collected, packed, stored for prolonged periods, and transported safely for use at geographic locales that can be remotely located from the encapsulation manufacture site, with the encapsulations comprising protected UV-curable optically active material that can be released as a UV-curable layer (released as a substrate and substrate surface treatment layer) that is then UV-cured, for example, on a substrate and/or substrate surface at the point of use.

According to present aspects, the encapsulations comprising encapsulated UV-curable optical agent hydrophobic resin mixture that can be applied to a substrate as a coating layer that is later UV-cured facilitates the ability to “pre-coat” a substrate, an assembly comprising the substrate, and larger objects that comprise the assembly including, for example, aircraft. That is, the present encapsulations that protect the encapsulated optical agent mixtures (until rupture and release of the coating material is desired) can serve as carriers and coating material layer delivery devices for coating material layers. The encapsulations can be stored for later use and later application to a substrate that may be remotely located, geographically, from the encapsulation preparation location.

In addition, the encapsulations can be applied to a substrate at one location, and left in an encapsulated state on the substrate, with the substrate “pre-coated” with the encapsulations. The release of the coating material from the encapsulations to foam an optically active coating layer, for example, via intentional encapsulation rupture can occur at a later desired time (e.g. after transport to and installation of a substrate, assembly, etc. to a final larger assembled object that can be, for example, an aircraft in an aircraft manufacturing facility.

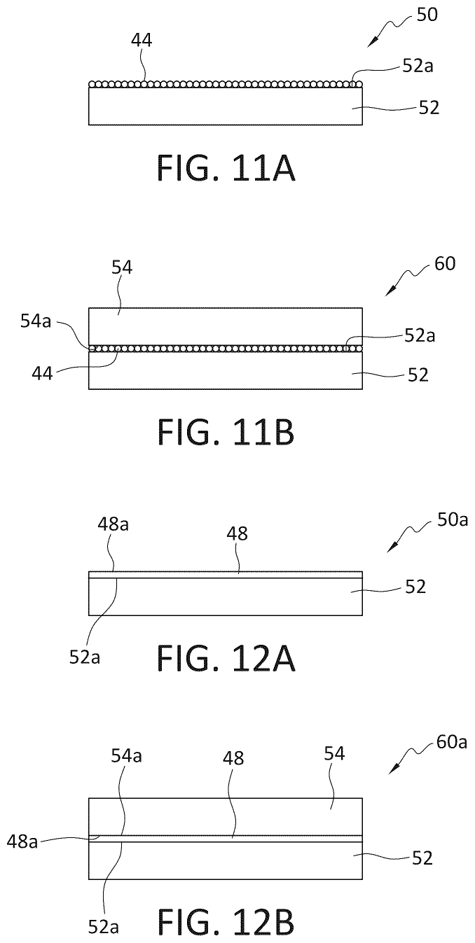

FIGS. 11A and 11B are side views of a substrate comprising the present encapsulations in place and in contact with at least one substrate surface. As shown in FIG. 11A, assembly 50 shows a layer of at least partially cured UV-curable hydrophobic resin encapsulations 44 deposited on a first substrate first surface 52a of first substrate 52. The layer of at least partially cured UV-curable hydrophobic resin encapsulations 44 is shown in the unruptured (referred to equivalently herein as “non-ruptured”) state.

FIG. 12A shows assembly 50a representing the at least partially UV-cured hydrophobic resin encapsulations now in a ruptured state, with the contents of the encapsulations having been released from the encapsulations to form a layer of uncured hydrophobic resin material 48 comprising the optically active agent that has now been UV-cured in the presence of a UV-curing regimen to form a UV-cured hydrophobic resin material layer 48a on the first substrate first surface 52a of first substrate 52.

In another present example, the optically active agent layer can be provided to a substrate surface that will rest adjacent a second substrate, with the optically active layer forming an interlayer between first and second substrates. FIG. 11B shows this alternate present aspect, with FIG. 11B showing assembly 60 comprising an “interlayer” of at least partially cured UV-curable hydrophobic resin encapsulations 44 deposited between first substrate first surface 52a of first substrate 52 and second substrate first surface 54a of second substrate 54. The layer of at least partially cured UV-curable hydrophobic resin encapsulations 44 is shown in the unruptured (referred to equivalently herein as “non-ruptured”) state.

FIG. 12B shows assembly 60a representing the at least partially cured UV-curable hydrophobic resin encapsulations now in a ruptured state, with the contents of the encapsulations (the UV-curable hydrophobic resin material 48) having been released from the encapsulations 44 to form a layer of uncured hydrophobic resin material layer 48 comprising the optically active agent that has now been UV-cured in the presence of a UV-light in a UV-curing regimen to form a UV-cured hydrophobic resin material layer 48a located at the interface of the first substrate first surface 52a of first substrate 52 and the second substrate first surface 54a of second substrate 54, with the UV-cured hydrophobic material resin material layer 48a (comprising the optically active agent) positioned between adjacent and adjoining substrates as an interlayer.

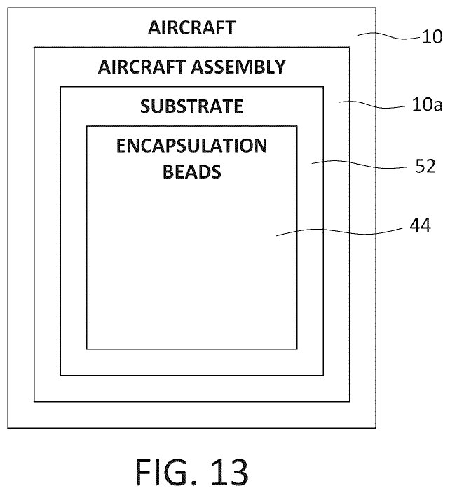

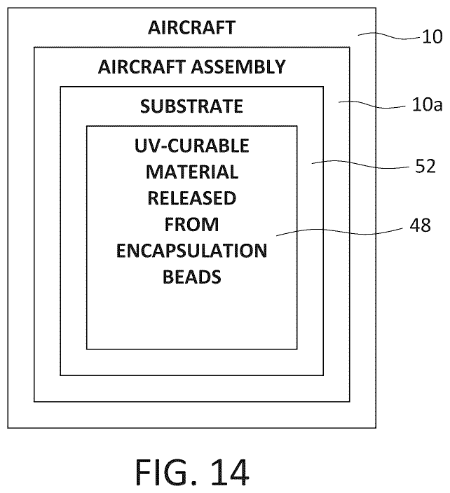

FIGS. 13 and 14 are box diagrams illustrating further present aspects that can include a structure, an assembly that can be an aircraft assembly comprising the structure, and an aircraft that can comprise an aircraft assembly comprising the structure that can further comprise the present encapsulations—encapsulation beads in the unruptured state (FIG. 13) and that can comprise a layer of UV-curable material released from the encapsulations that can then be UV-cured (See FIG. 14).

According to a present aspect, as shown in FIG. 13, a vehicle in the form of an aircraft 10 comprises an aircraft assembly 10a that can be located on the aircraft 10, and that can include, for example, a fuselage, a wing, an engine, etc., and that can have an exterior surface. The aircraft assembly 10a can comprise a substrate 52 that can further comprise the presently disclosed encapsulations 44 in an unruptured state (referred to equivalently herein as “encapsulation beads” in an unruptured state) that can be applied to and that can otherwise be positioned on a surface of the substrate as an encapsulation layer in an unruptured state.

In another present aspect, as shown in FIG. 14, a vehicle in the form of an aircraft 10 comprises an aircraft assembly 10a that can be located on the aircraft 10, and that can include, for example, a fuselage, a wing, an engine, etc., and that can have an exterior surface. The aircraft assembly 10a can comprise a substrate 52 that can further comprise a layer of UV-curable material 48 released presently disclosed encapsulations in a ruptured state (referred to equivalently herein as “encapsulation beads” in a ruptured state) that can be applied to and that can otherwise be positioned on a surface of the substrate as a UV-curable optical agent material layer 48 in an uncured state. Although not shown in FIG. 14, the UV-curable optical agent material layer 48 in an uncured state can then be exposed to UV-light in a UV-curing regimen, with the UV-curable optical agent material layer 48 then UV-cured to form a UV-cured optical agent material layer.

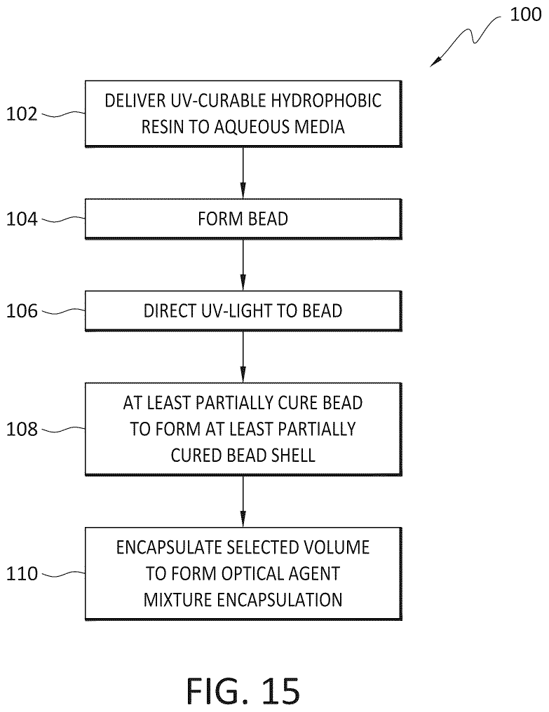

FIGS. 15, 16, 17, 18, and 19 are flow diagrams outlining methods according to present aspect. FIG. 15 outlines a method 100 for making a substrate surface treatment comprising an optically active agent, the method 100 including delivering 102 an initial volume of a UV-curable hydrophobic resin mixture from a UV-curable hydrophobic resin delivery device into an aqueous solution, with the UV-curable hydrophobic resin delivery device in communication with a UV-curable hydrophobic resin supply, with the UV-curable hydrophobic resin mixture comprising a UV-curable hydrophobic resin material, a metal oxide material, and at least one optical agent (e.g., a pigment, a dye, a paint, an industrial tracer, etc.) The method 100 further includes forming 104 the initial volume of the UV-curable hydrophobic resin mixture in the aqueous solution into a UV-curable hydrophobic resin bead, with the UV-curable hydrophobic resin bead comprising a UV-curable hydrophobic resin bead outer surface, and with the UV-curable hydrophobic resin bead outer surface in contact with the aqueous solution. Method 100 further includes directing 106 UV light from a UV light source to the UV-curable hydrophobic resin bead in the aqueous media, and at least partially UV-curing 108 the UV-curable hydrophobic resin bead outer surface to form an at least partially UV-cured hydrophobic resin bead outer shell comprising an at least partially UV-cured hydrophobic resin bead outer shell selected thickness. Method 100, further includes encapsulating 110 an encapsulated volume of the UV-curable hydrophobic resin mixture within the at least partially UV-cured hydrophobic resin bead outer shell to form an at least partially cured hydrophobic resin bead comprising the encapsulated volume of the UV-curable hydrophobic resin mixture.

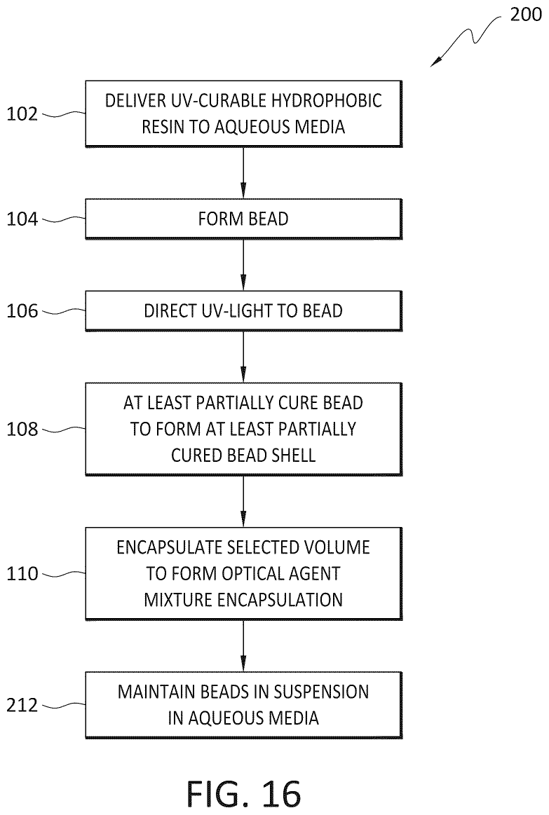

FIG. 16 outlines a method 200 for making a substrate surface treatment comprising an optically active agent, the method 200 including delivering 102 an initial volume of a UV-curable hydrophobic resin mixture from a UV-curable hydrophobic resin delivery device into an aqueous solution, with the UV-curable hydrophobic resin delivery device in communication with a UV-curable hydrophobic resin supply, with the UV-curable hydrophobic resin mixture comprising a UV-curable hydrophobic resin material, a metal oxide material, and at least one optical agent (e.g., a pigment, a dye, a paint, an industrial tracer, etc.) The method 200 further includes forming 104 the initial volume of the UV-curable hydrophobic resin mixture in the aqueous solution into a UV-curable hydrophobic resin bead, with the UV-curable hydrophobic resin bead comprising a UV-curable hydrophobic resin bead outer surface, and with the UV-curable hydrophobic resin bead outer surface in contact with the aqueous solution. Method 200 further includes directing 106 UV light from a UV light source to the UV-curable hydrophobic resin bead in the aqueous media, and at least partially UV-curing 108 the UV-curable hydrophobic resin bead outer surface to form an at least partially UV-cured hydrophobic resin bead outer shell comprising an at least partially UV-cured hydrophobic resin bead outer shell selected thickness. Method 200, further includes encapsulating 110 an encapsulated volume of the UV-curable hydrophobic resin mixture within the at least partially UV-cured hydrophobic resin bead outer shell to form an at least partially cured hydrophobic resin bead comprising the encapsulated volume of the UV-curable hydrophobic resin mixture. Method 200 further includes maintaining 202 the UV-curable hydrophobic resin bead in suspension in the aqueous solution during encapsulating the encapsulated volume of the UV-curable hydrophobic resin mixture within the at least partially UV-cured hydrophobic resin bead outer shell (e.g., during UV-curing the UV-curable hydrophobic resin bead to form the at least partially UV-cured encapsulation).

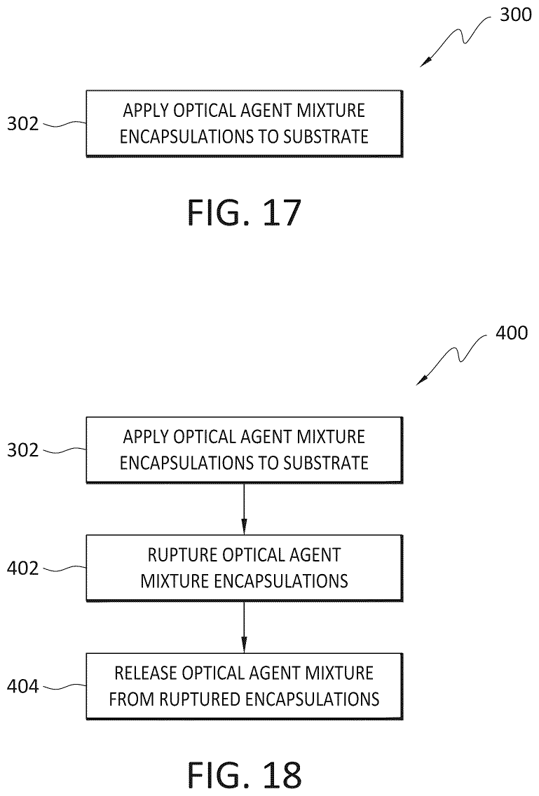

FIG. 17 outlines a method 300 for delivering an optical agent mixture encapsulation to a substrate, according to present aspects, with method 300 including applying 302 the optical agent mixture encapsulation to a substrate surface, with the optical agent mixture encapsulation including an at least partially UV-cured hydrophobic resin mixture shell, an encapsulated volume of UV-curable hydrophobic resin mixture bounded by the at least partially UV-cured hydrophobic resin mixture shell, and wherein the encapsulated volume of UV-curable hydrophobic resin mixture includes a UV-curable hydrophobic resin material, a metal oxide material, and at least one optical agent, and wherein the at least partially UV-cured hydrophobic resin mixture shell and the encapsulated volume of UV-curable hydrophobic resin mixture comprise the same material composition.

FIG. 18 outlines a method 400 for delivering an optical agent mixture to a substrate, according to present aspects, with method 400 including applying 302 the optical agent mixture encapsulation to a substrate surface, with the optical agent mixture encapsulation including an at least partially UV-cured hydrophobic resin mixture shell, an encapsulated volume of UV-curable hydrophobic resin mixture bounded by the at least partially UV-cured hydrophobic resin mixture shell, and wherein the encapsulated volume of UV-curable hydrophobic resin mixture includes a UV-curable hydrophobic resin material, a metal oxide material, and at least one optical agent, and wherein the at least partially UV-cured hydrophobic resin mixture shell and the encapsulated volume of UV-curable hydrophobic resin mixture comprise the same material composition. Method 400 further includes rupturing 402 the at least partially UV-cured hydrophobic resin mixture shell to form a ruptured optical agent mixture encapsulation, and releasing 404 to the substrate the encapsulated volume of UV-curable hydrophobic resin mixture from the ruptured optical agent mixture encapsulation to form a released volume of optical agent mixture on the substrate.

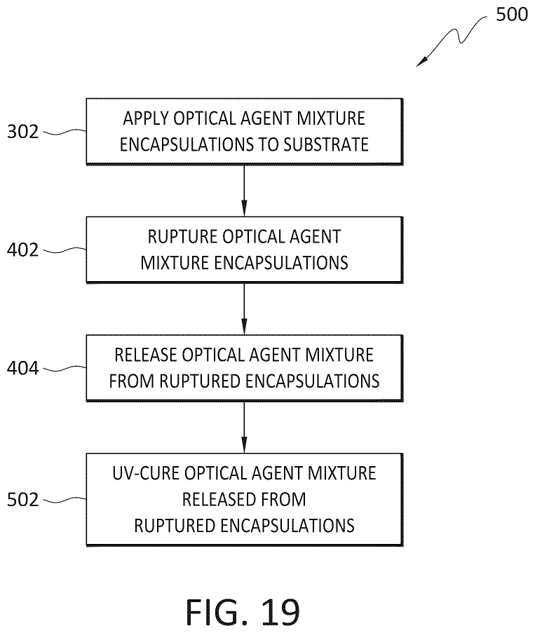

FIG. 19 outlines a method 500 for delivering an optical agent mixture to a substrate, according to present aspects, with method 500 including applying 302 the optical agent mixture encapsulation to a substrate surface, with the optical agent mixture encapsulation including an at least partially UV-cured hydrophobic resin mixture shell, an encapsulated volume of UV-curable hydrophobic resin mixture bounded by the at least partially UV-cured hydrophobic resin mixture shell, and wherein the encapsulated volume of UV-curable hydrophobic resin mixture includes a UV-curable hydrophobic resin material, a metal oxide material, and at least one optical agent, and wherein the at least partially UV-cured hydrophobic resin mixture shell and the encapsulated volume of UV-curable hydrophobic resin mixture comprise the same material composition. Method 400 further includes rupturing 402 the at least partially UV-cured hydrophobic resin mixture shell to form a ruptured optical agent mixture encapsulation, and releasing 404 to the substrate the encapsulated volume of UV-curable hydrophobic resin mixture from the ruptured optical agent mixture encapsulation to form a released volume of optical agent mixture on the substrate. Method 500 further includes UV-curing 502 the released volume of UV-curable hydrophobic resin mixture released to the substrate surface to form a cured optical agent mixture layer on the substrate.

According to present aspects, the methods 100, 200, 300, 400, 500 shown, respectively, in FIGS. 15, 16, 17, 18, and 19, and disclosed herein, can employ the presently disclosed UV-curable hydrophobic resin mixtures, the at least partially UV-curable hydrophobic resin mixture encapsulations in an unruptured state, the at least partially UV-curable hydrophobic resin mixture encapsulations in a ruptured state, and the optically active agent material layer released from the present encapsulations in an uncured state and in a UV-cured state as shown in FIGS. 2, 3, 4A, 4B, 4C, 4D, 5, 6, 7, 8A, 8B, 8C11A, 11B, 12A, 12B, 13, 14, and as described herein.

The term “substantially spherical” as used herein means that a particular physical element, physical positioning, and/or physical shape, orientation, etc., is almost completely or is nearly completely spherically-shaped, etc.

The present aspects may, of course, be carried out in other ways than those specifically set forth herein without departing from essential characteristics of the present disclosure. The present aspects are to be considered in all respects as illustrative and not restrictive, and all changes coming within the meaning and equivalency range of the appended claims are intended to be embraced therein.

What is claimed is:

1. A method for making a substrate surface treatment, the method comprising:
delivering an initial volume of a UV-curable hydrophobic resin mixture from a UV-curable hydrophobic resin delivery device into an aqueous solution, said UV-curable hydrophobic resin delivery device in communication with a UV-curable hydrophobic resin supply, said UV-curable hydrophobic resin mixture comprising a UV-curable hydrophobic resin material, said UV-curable hydrophobic resin mixture further comprising a metal oxide material, said UV-curable hydrophobic resin mixture further comprising at least one optical agent;
forming the initial volume of the UV-curable hydrophobic resin mixture in the aqueous solution into a UV-curable hydrophobic resin bead, said UV-curable hydrophobic resin bead comprising a UV-curable hydrophobic resin bead outer surface, said UV-curable hydrophobic resin bead outer surface in contact with the aqueous solution;
directing UV-light from a UV-light source to the UV-curable hydrophobic resin bead in the aqueous solution; and
at least partially UV-curing the UV-curable hydrophobic resin bead outer surface to form an at least partially UV-cured hydrophobic resin bead outer shell comprising an at least partially UV-cured hydrophobic resin bead outer shell selected thickness; and
encapsulating an encapsulated volume of the UV-curable hydrophobic resin mixture within the at least partially UV-cured hydrophobic resin bead outer shell to form an at least partially cured hydrophobic resin bead comprising the encapsulated volume of the UV-curable hydrophobic resin mixture.

2. The method of claim 1, further comprising:
maintaining the UV-curable hydrophobic resin bead in suspension in the aqueous solution during encapsulating the encapsulated volume of the UV-curable hydrophobic resin mixture within the at least partially UV-cured hydrophobic resin bead outer shell.

3. The method of claim 1, wherein the aqueous solution comprises an aqueous solution density configured to maintain the UV-curable hydrophobic resin bead in suspension in the aqueous solution during forming of the at least partially UV-cured hydrophobic resin bead outer shell, said aqueous solution comprising a density ranging from about 40 g/cm³ to about 200 g/cm³.

4. The method of claim 1, wherein the UV-curable hydrophobic resin material comprises at least one of a UV-curable epoxy, a UV-curable urethane acrylate, a UV-curable polyester acrylate, a UV-curable vinyl acrylate, a UV-curable polysiloxane, a UV-curable silicone, and combinations thereof.

5. The method of claim 1, wherein the UV-curable hydrophobic resin material comprises a UV-curable acrylic urethane.

6. The method of claim 1, wherein the at least one optical agent comprises at least one of a dye, a pigment, a magnetic material, an electrically conductive material, and combinations thereof.

7. The method of claim 1 wherein the metal oxide material comprises at least one of aluminum oxide, cobalt oxide, gallium oxide, hafnium oxide, iron oxide, nickel oxide, niobium oxide, molybdenum oxide, lanthanum oxide, rhenium oxide, scandium oxide, silicon oxide, titanium oxide, tantalum oxide, vanadium oxide, tungsten oxide, yttrium oxide, zirconium oxide, and combinations thereof.

8. The method of claim 1, wherein the metal oxide material comprises at least one of aluminum oxide, iron oxide, tantalum oxide, titanium oxide, vanadium oxide, zirconium oxide, and combinations thereof.

9. The method of claim 1 wherein the metal oxide material is provided to the UV-curable hydrophobic resin material as a powdered metal oxide, said powdered metal oxide provided to the UV-curable hydrophobic resin mixture in a selected amount configured to dissolve in the UV-curable hydrophobic resin material.

10. The method of claim 1, wherein the at least partially-cured hydrophobic resin bead comprising the encapsulated volume of the UV-curable hydrophobic resin mixture comprises an encapsulation efficiency greater than about 60%, said at least partially UV-cured hydrophobic resin bead outer shell comprising at the least partially UV-cured hydrophobic resin bead outer shell selected thickness of less than about 60 μm, and said the metal oxide material comprising a weight ratio of the metal oxide material:UV-curable hydrophobic resin material of about 1.5:10.

11. The at least partially UV-cured hydrophobic resin bead comprising the encapsulated volume of the UV-curable hydrophobic resin mixture made according to the method of claim 1.

12. A method for delivering a substrate surface treatment composition to a substrate surface, the method comprising:
applying an at least partially UV-cured encapsulation to a substrate surface, said at least partially UV-cured encapsulation comprising:
an at least partially UV-cured encapsulation outer shell;
an encapsulated volume of UV-curable hydrophobic resin mixture bounded by the at least partially UV-cured encapsulation outer shell;
wherein said encapsulated volume of UV-curable hydrophobic resin mixture comprises:
a UV-curable hydrophobic resin material;
a metal oxide material; and
at least one optical agent; and
wherein the at least partially UV-cured encapsulation outer shell and the encapsulated volume of UV-curable hydrophobic resin mixture comprise the same material.

13. The method of claim 12, wherein the UV-curable hydrophobic resin material comprises at least one of a UV-curable epoxy, a UV-curable urethane acrylate, a UV-curable polyester acrylate, a UV-curable vinyl acrylate, a UV-curable polysiloxane, a UV-curable silicone, and combinations thereof.

14. The method of claim 12, wherein the UV-curable hydrophobic resin material comprises a UV-curable acrylic urethane.

15. The method of claim 12, wherein the at least one optical agent comprises at least one of a dye, a pigment, a magnetic material, an electrically conductive material, and combinations thereof.

16. The method of claim 12, wherein the metal oxide material comprises at least one of aluminum oxide, cobalt oxide, gallium oxide, hafnium oxide, iron oxide, nickel oxide, niobium oxide, molybdenum oxide, lanthanum oxide, rhenium oxide, scandium oxide, silicon oxide, titanium oxide, tantalum oxide, vanadium oxide, tungsten oxide, yttrium oxide, zirconium oxide, and combinations thereof.

17. The method of claim 12, wherein the metal oxide material comprises at least one of aluminum oxide, iron oxide, tantalum oxide, titanium oxide, vanadium oxide, zirconium oxide, and combinations thereof.

18. The method of claim 12 further comprising:
rupturing the at least partially UV-cured encapsulation outer shell to form a ruptured optical agent mixture encapsulation; and
releasing to the substrate surface the encapsulated volume of UV-curable hydrophobic resin mixture from the ruptured optical agent mixture encapsulation to form a released volume of optical agent mixture on the substrate surface.

19. The method of claim 18 further comprising:
UV-curing the released volume of optical agent mixture on the substrate surface to form a UV-cured optical agent mixture layer on the substrate surface.

20. A substrate comprising the at least partially UV-cured encapsulation made according to the method of claim 12.

21. An aircraft assembly the at least partially UV-cured encapsulation made according to the method of claim 12.

22. An aircraft comprising the at least partially UV-cured encapsulation made according to the method of claim 12.

23. A substrate comprising the UV-cured optical agent mixture layer made according to the claim 19.

24. An aircraft assembly comprising the UV-cured optical agent mixture layer made according to the method of claim 19.

25. An aircraft comprising the UV-cured optical agent mixture layer made according to the claim 19.

26. An encapsulated substrate surface treatment material bead comprising:
a volume of encapsulated UV-curable hydrophobic resin mixture; and
an at least partially UV-cured hydrophobic resin mixture outer shell configured to encapsulate said volume of encapsulated UV-curable hydrophobic resin mixture to form the encapsulated substrate surface treatment material bead;
wherein the volume of encapsulated UV-curable hydrophobic resin mixture and the at least partially UV-cured hydrophobic resin mixture outer shell comprise an identical hydrophobic resin mixture; and
wherein said identical hydrophobic resin mixture comprises:
a hydrophobic resin mixture;
a metal oxide material; and
at least one optical agent.

27. The encapsulated substrate surface treatment material bead of claim 26, wherein the at least partially UV-cured hydrophobic resin mixture outer shell and the encapsulated UV-curable hydrophobic resin mixture comprises at least one of a UV-curable epoxy, a UV-curable urethane acrylate, a UV-curable polyester acrylate, a UV-curable vinyl acrylate, a UV-curable polysiloxane, a UV-curable silicone, and combinations thereof.

28. The encapsulated substrate surface treatment material bead of claim 26, wherein the optical agent comprises at least one of a dye, a pigment, a magnetic material, an electrically conductive material, an electrically insulative material, and combinations thereof.

29. The encapsulated substrate surface treatment material bead of claim 26, wherein the metal oxide material comprises at least one of aluminum oxide, cobalt oxide, gallium oxide, hafnium oxide, iron oxide, nickel oxide, niobium oxide, molybdenum oxide, lanthanum oxide, rhenium oxide, scandium oxide, silicon oxide, titanium oxide, tantalum oxide, vanadium oxide, tungsten oxide, yttrium oxide, zirconium oxide, and combinations thereof.

30. The encapsulated substrate surface treatment material bead of claim 26, wherein the metal oxide material comprises at least one of aluminum oxide, iron oxide, tantalum oxide, titanium oxide, vanadium oxide, zirconium oxide, and combinations thereof.

31. The encapsulated substrate surface treatment material bead of claim 26, wherein the at least partially UV-cured hydrophobic resin mixture outer shell comprises a shell thickness ranging from about 1000 μm to about 6000 μm.

32. The encapsulated substrate surface treatment material bead of claim 26, wherein the encapsulated substrate surface treatment material bead comprises an encapsulation efficiency greater than about 60%, said at least partially UV-cured hydrophobic resin mixture outer shell comprising a shell thickness of less than about 60 μm, and said metal oxide material comprising a weight ratio of the metal oxide material:UV-curable hydrophobic resin material of about 1.5:10.
